(19) United States
(12) Patent Application Publication
(10) Pub. No.: US 2009/0088526 A1
(43) Pub. Date: Apr. 2, 2009

(54) COMPOSITION COMPRISING A COPOLYMER BASED ON ACRYLONITRILE AND A VINYLAROMATIC MONOMER, A COPOLYMER COMPRISING AT LEAST THREE BLOCKS AND A PARTICULATE COPOLYMER OF THE CORE-SHELL TYPE

(76) Inventors: Laurent Gervat, Les Clays/ boie (FR); Christophe Navarro, Lahonce (FR); Pierre Gerard, Denguin (FR); Stephane Girois, Brignais (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/096,506

(22) PCT Filed: Dec. 8, 2006
(86) PCT No.: PCT/EP06/69463

§ 371 Date: Nov. 17, 2008

Related U.S. Application Data
(60) Provisional application No. 60/775,662, filed on Feb. 22, 2006.

(30) Foreign Application Priority Data
Dec. 8, 2005 (FR) 0512480

(51) Int. Cl. C08L 53/00; C08L 51/06; C08L 25/08

(52) U.S. Cl. 525/71; 525/93; 525/94

(57) ABSTRACT

The invention relates to an impact-resistant transparent composition comprising a copolymer having repeat units resulting from the polymerization of acrylonitrile and of at least one vinylaromatic monomer, a particulate block copolymer and a core-shell copolymer.

### TECHNICAL FIELD

The invention relates to transparent compositions exhibiting excellent mechanical properties, especially as regards impact strength.

More precisely, it relates to a composition comprising the combination of a copolymer based on acrylonitrile and a vinylaromatic monomer, of a particulate copolymer comprising at least three blocks, and of a particulate copolymer comprising a core and at least one shell (called core-shell copolymers).

The invention is particularly applicable in fields requiring the use of transparent impact-resistant materials, such as the motor vehicle, aeronautical, aerospace, nautical, domestic and electronic fields, and also the field of toys.

### PRIOR ART

In the field of transparent materials, it is common practice to add additives in order to give these materials mechanical strength. However, the addition of these additives generally impairs the transparency of the materials.

The difficulty at the present time is therefore to produce materials that exhibit both excellent transparency, for glazing applications, and excellent mechanical strength.

The inventors set the objective of producing such materials.

Thus, they have discovered, surprisingly, that by combining three particulate copolymers, including a copolymer of the core-shell type and a block copolymer, a composition is obtained that has a very high impact strength and excellent transparency, enabling it to be used for the applications described above.

### SUMMARY OF THE INVENTION

Thus, the present invention, according to a first subject, relates to a composition comprising:

at least one copolymer (D) comprising repeat units that result from the polymerization of acrylonitrile with at least one vinylaromatic monomer;

at least one particulate copolymer in the form of particles having an elastomeric core and at least one thermoplastic shell; and

at least one block copolymer comprising at least three blocks, A, B and C, the three blocks A, B and C being linked together in this order, each block being either a homopolymer or a copolymer obtained from two or more monomers, the A block being linked to the B block and the B block to the C block by means of a covalent bond or of an intermediate bridging group linked to one of these blocks via a covalent bond and to the other block via another covalent bond and such that:

the A block is compatible with the copolymer (D);

the B block is incompatible with the copolymer (D) and is incompatible with the A block; and

the C block is incompatible with the B block.

The copolymer (D) may be present in the composition with a content ranging from 27 to 80% by weight relative to the total weight of the composition, for example 30 to 80% by weight.

As examples of vinylaromatic monomers that can be used in the formation of the copolymer (D), mention may be made of styrene, α-methylstyrene and chlorostyrene.

As examples of copolymers (D), mention may be made of:

linear copolymers resulting from the copolymerization of styrene and acrylonitrile (known by the abbreviation SAN);

graft copolymers comprising a main chain resulting from the polymerization of butadiene, preferably predominantly 1,4-butadiene, or from the copolymerization of butadiene, acrylonitrile and grafts resulting from the polymerization of styrene and acrylonitrile (these graft copolymers being sometimes denoted by the abbreviation ABS); and

blends of these copolymers.

The SAN copolymers may be included in a blend comprising elastomers. These elastomers may for example be EPR (the abbreviation for ethylene-propylene rubber or ethylene-propylene elastomer), EPDM (the abbreviation for ethylene-propylene-diene monomer rubber or elastomer), polybutadiene, acrylonitrile/butadiene copolymers, polyisoprene and isoprene-acrylonitrile copolymers.

In the copolymers (D) just mentioned, some of the styrene may be replaced with unsaturated monomers that can be copolymerized with styrene, such as α-methylstyrene and (meth)acrylic esters.

Copolymers (D) that can be used are those described in U.S. Pat. No. 6,689,827.

The number-average molecular weight of the copolymer (D) is advantageously between 10000 and 350000 g/mol and preferably between 20000 and 200000 g/mol. Advantageously, the percentage by weight of acrylonitrile in the copolymer (D) is between 2 and 50%, more often between 9 and 40%, preferably between 12 and 35% and more advantageously still between 22 and 30%.

The block copolymer in the compositions of the invention may be present with a content ranging from 0.3 to 20%, and more advantageously between 0.3 and 10% and even more between 0.5 and 5% by weight relative to the total weight of the composition.

As mentioned above, the block copolymer comprises at least three blocks A, B and C in such a way that the A block is linked to the B block and the B block to the C block by means of one or more single covalent bonds. In the case of several covalent bonds, between the A block and the B block and/or between the B block and the C block, there may be a single unit or a linked sequence of units serving to join the blocks together. In the case of a single unit, the latter may come from a monomer, called a moderator, used in the synthesis of the triblock. In the case of a linked sequence of units, this may be an oligomer resulting from the linking of monomer units of at least two different monomers in an alternating or random order. Such an oligomer may link the A block to the B block, and the same oligomer or a different oligomer may link the B block to the C block.

The A block of the block copolymer is regarded as being compatible with the copolymer (D) if the A polymer identical to this block (and therefore without B and C sequences) is compatible with this copolymer (D) in the melt. Likewise, the A and B blocks are regarded as being incompatible if the A and B polymers identical to these blocks are incompatible. In general, compatibility between two polymers should be understood to mean the ability of one to dissolve in the other in the melt, or else their complete miscibility. If this is not the case, the polymers or blocks are called incompatible.

The lower the enthalpy of mixing of two polymers, the greater their compatibility. In some cases, there is a favourable specific interaction between the monomers which results in a negative enthalpy of mixing for the corresponding polymers. In the context of the present invention, it is preferred to use compatible polymers whose enthalpy of mixing is negative or zero.

However, the enthalpy of mixing cannot be conventionally measured for all polymers, and therefore the compatibility can only be determined indirectly, for example by viscoelastic analytical measurements in torsion or in oscillation, or else by differential calorimetry. For compatible polymers, two glass transition temperatures (T_{g}) can be detected for the blend: at least one of the two T_{g} is different from the T_{g} of the pure compounds and lies within the temperature range between the two T_{g} of the pure compounds. A blend of two completely miscible polymers has a single T_{g}.

Other experimental methods may be used to demonstrate the compatibility of the polymers, such as turbidity measurements, light-scattering measurements and infrared measurements (L. A. Utracki, Polymer Alloys and Blends, pp. 64-117).

Miscible or compatible polymers are listed in the literature—see, for example J. Brandrup and E. H. Immergut: Polymer Handbook, 3rd Edition, Wiley & Sons 1979, New York 1989, pp. VI/348 to VI/364; O. Olabisi, L. M. Robeson and M. T. Shaw: Polymer Miscibility, Academic Press, New York 1979, pp. 215-276; L. A. Utracki: Polymer Alloys and Blends, Hanser Verlag, Munich 1989. The lists appearing in these references are given by way of illustration and are not, of course, exhaustive.

Advantageously, the A block is chosen from alkyl (alkyl)acrylate homopolymers and copolymers. Examples of alkyl (alkyl)acrylate that may be mentioned include methyl methacrylate (MMA), methyl acrylate and ethyl acrylate. The A block may also be a homopolymer or copolymer based on vinyl acetate and its derivatives (such as the VeoVA polymers sold by Shell).

Advantageously, the A block is poly(methyl methacrylate) (PMMA). Preferably, this PMMA is syndiotactic and its glass transition temperature T_{g(A)}, measured by differential thermal analysis, is from +120° C. to +150° C.

Advantageously, the T_{g} of the B block is below 0° C., preferably below −40° C. and better still between −100° C. and −50° C.

The monomer used to synthesize the B block may be a diene chosen from butadiene, isoprene, 2,3-dimethyl-1,3-butadiene, 1,3-pentadiene and 2-phenyl-1,3-butadiene. Advantageously, the B block is chosen from polydienes, especially polybutadiene, polyisoprene and their random copolymers, or else from partially or completely hydrogenated polydienes. Among polybutadienes, it is advantageous to use those whose T_{g} is the lowest, for example poly(1,4-butadiene) whose T_{g} (around −90° C.) is less than that (around 0° C.) of poly(1,2-butadiene). The blocks B may also be hydrogenated. This hydrogenation is carried out using the standard techniques.

The monomer used to synthesize the B block may also be an alkyl (meth)acrylate such as: ethyl acrylate (T_{g}=−24° C.), butyl acrylate, preferably n-butyl acrylate (T_{g}=−54° C.), 2-ethylhexyl acrylate (T_{g}=−85° C.), hydroxyethyl acrylate (T_{g}=−15° C.) and 2-ethylhexyl methacrylate (T_{g}=−10° C.). It is advantageous to use butyl acrylate. The acrylates are different from those of the A block in order to satisfy the condition that B and A must be incompatible.

Preferably, the B block is a poly(1,4-butadiene).

Preferably, the C block has a glass transition temperature T_{g(C)} or a melting point T_{m(C)} greater than the T_{g(B)} of the B block. This characteristic means that the C block can either be in the glassy state or in a partially crystalline state and the B block can be in the elastomeric state, for the same service temperature Tₛ.

According to the present invention, it is possible to choose the nature of the B blocks in order to have a certain defined T_{g(B)} and thus, at the service temperature Tₛ of the material or of the article formed from the blend, to have these B polymer blocks in an elastomeric or flexible state. On the other hand, since the C polymer blocks can have a T_{g}(c) or a Tₘ greater than T_{g(B)}, they may be in a relatively rigid glassy state at the same service temperature.

Since the C blocks may be incompatible with the copolymer (D) and are incompatible with the B blocks, they form a rigid discrete phase within the composition, forming nanodomains included in the composition and serving as anchoring points in the region of one of the ends of each B block. The other end of each B block is linked to an A block which has a strong affinity with the copolymer (D). This strong affinity provides a second anchoring point in the region of the second end of the B block.

Advantageously, the C block is chosen from styrene or α-methylstyrene homopolymers or copolymers.

According to the present invention, it is also possible to choose a C block compatible with the copolymer (D) having a composition as described in the case of the A block. It is then often advantageous to take a C block identical to the A block, by giving the copolymer the ABA form.

The block copolymers that contain sequences deriving from alkyl (alkyl)acrylates may especially be prepared by anionic polymerization, for example using the processes described in Patent Applications EP 524 054 and EP 749 987.

Preferably, the block copolymer is an ABC triblock copolymer, for example a poly(methyl methacrylate-b-butadiene-b-styrene).

The block copolymer, especially when it is an ABC triblock copolymer may contain, as by-products of its synthesis, a BC diblock copolymer and possibly the homopolymer C. The ABC triblock copolymer may also contain, as by-products of its synthesis, an AB diblock copolymer and possibly the homopolymer A.

This is because the synthesis of a triblock copolymer ABC is preferably carried out by joining, in succession, the A block to the B block and then to the C block, or conversely the C block to the B block and then to the A block, depending on the nature of the three blocks A, B and C, the A block being by definition that block which is compatible with (D). The ABC triblock copolymer may also contain star or symmetrical linear block copolymers of the ABA or CBC type.

Advantageously, the total amount by weight of the synthesis by-products, that is to say of these homopolymers A and C or these AB, BC, ABA and CBC block copolymers, is less than twice the amount of ABC triblock. Preferably, this amount is less than one times and better still 0.5 times the amount of ABC triblock. More specifically, the by-products are essentially the BC diblock, it being possible for the amount of BC to be between 10 and 35 parts by weight, per 90 to 65 parts of ABC respectively, and advantageously about 15 parts per 85 parts of ABC.

Advantageously, the ABC triblock copolymer consists of:

10 to 90 and preferably 15 to 80 parts by weight of A blocks;

5 to 70 and preferably 10 to 55 parts by weight of B blocks;

5 to 70 and preferably 10 to 65 parts by weight of C blocks.

The number-average molecular weights (in g/mol) of the various blocks are generally between:

10000 and 150000, and preferably 15000 and 100000 in the case of A;

5000 and 60000, and preferably 10000 and 50000 in the case of B; and

5000 and 50000, and preferably 8000 and 40000 in the case of C.

In the abovementioned proportions of 0.3 to 20% by weight of the block copolymer, these proportions include the possible by-products of the synthesis.

As mentioned above, the compositions of the invention also include a particulate copolymer in the form of fine particles having an elastomeric core and at least one thermoplastic shell, the size of the particles generally being less than 1 μm and advantageously between 50 and 300 nm. This particulate copolymer is prepared by emulsion polymerization.

The particulate copolymer may be present in the composition with a content ranging from 20 to 50%, preferably 35 to 40%, by weight relative to the total weight of the composition.

The core may for example consist of:

an isoprene or butadiene homopolymer; or

isoprene copolymers with at most 30 mol % of a vinyl monomer; or

butadiene copolymers with at most 30 mol % of a vinyl monomer.

The vinyl monomer may be styrene, an alkylstyrene, acrylonitrile or an alkyl(meth)acrylate.

The core may also consist of:

a homopolymer resulting from the polymerization of an alkyl(meth)acrylate; or

copolymers resulting from the polymerization of an alkyl(meth)acrylate with at most 30 mol % of a monomer chosen from another alkyl(meth)acrylate and a vinyl monomer.

Advantageously, the alkyl(meth)acrylate is n-butyl acrylate. The vinyl monomer may be styrene, an alkylstyrene, acrylonitrile, butadiene or isoprene.

Advantageously, the core may be partly or completely crosslinked. All that is required is to add at least difunctional monomers during the preparation of the core, which monomers may be chosen from poly(meth)acrylic esters of polyols such as butylene di(meth)acrylate and trimethylolpropane trimethacrylate. Other difunctional monomers are for example divinylbenzene, trivinylbenzene, vinyl acrylate and vinyl methacrylate. It is also possible to crosslink the core by introducing thereinto, by grafting or as comonomer during the polymerization, unsaturated functional monomers such as unsaturated carboxylic anhydrides, unsaturated carboxylic acids, unsaturated epoxides and allyl cyanurates. For example, mention may be made of maleic anhydride, (meth)acrylic acid and glycidyl methacrylate.

The shell or shells may consist of:

a styrene, alkylstyrene or methyl methacrylate homopolymer; or

a copolymer comprising at least 70 mol % of a predominant monomer, chosen from styrene, an alkylstyrene or methyl methacrylate, and at least one comonomer chosen from an alkyl(meth)acrylate, vinyl acetate, acrylonitrile, styrene and an alkylstyrene, it being understood that the predominant monomer and the comonomer are different.

The shell may be functionalized by introducing thereinto, by grafting or as comonomer during the polymerization, unsaturated functional monomers such as unsaturated carboxylic acid anhydrides, unsaturated carboxylic acids, unsaturated epoxides or allyl cyanurates. For example, mention may be made of maleic anhydride, (meth)acrylic acid and glycidyl methacrylate.

As examples of particulate copolymers, mention may be made of core-shell copolymers having a polystyrene core and core-shell copolymers having a polymethyl methacrylate shell. There are also core-shell copolymers having two shells, one made of polystyrene and the other, on the outside, made of polymethyl methacrylate. Examples of particulate copolymers, and their methods of preparation, are described in the following patents: U.S. Pat. No. 4,180,494, U.S. Pat. No. 3,808,180, U.S. Pat. No. 4,096,202, U.S. Pat. No. 4,260,693, U.S. Pat. No. 3,287,443, U.S. Pat. No. 3,657,391, U.S. Pat. No. 4,299,928, U.S. Pat. No. 3,985,704, U.S. Pat. No. 5,773,520.

Advantageously, the core represents, by weight, 70 to 90% of the particulate copolymer and the shell 30 to 10%.

The particulate copolymer may be of the soft/hard type. As examples of soft/hard particulate copolymers, mention may be made of those comprising:

(i) 75 to 80 parts of a core comprising at least 93 mol % butadiene, 5 mol % styrene and 0.5 to 1 mol % divinylbenzene; and

(ii) 25 to 20 parts of two shells essentially of the same weight, one, on the inside, made of polystyrene and the other, on the outside, made of polymethyl methacrylate.

Other examples of soft/hard particulate copolymers that may be mentioned are those having a polybutyl acrylate or butyl acrylate/butadiene copolymer core and a polymethyl methacrylate shell.

The particulate copolymer may also be of the hard/soft/hard type, that is to say it contains, in the following order, a hard core, a soft shell and a hard shell. The hard parts may consist of the polymers of the shell of the above soft/hard copolymers and the soft part may consist of the polymers of the core of the above soft/hard copolymers.

As examples of hard/soft/hard particulate copolymers, mention may be made of those comprising:

(i) a core made of a methyl methacrylate/ethyl acrylate copolymer;

(ii) a shell of an n-butyl acrylate/styrene copolymer; and

(iii) a shell made of a methyl methacrylate/ethyl acrylate copolymer.

The particulate copolymer may also be of the hard (core)/soft/semi-hard type. In this case, the “semi-hard” outer shell consists of two shells, one the intermediate shell and the other the outer shell. The intermediate shell may be a copolymer of methyl methacrylate, styrene and at least one monomer chosen from alkyl acrylates, butadiene and isoprene. The outer shell may be a polymethyl methacrylate homopolymer or a copolymer of methyl methacrylate, styrene and at least one monomer chosen from alkyl acrylates, acrylamides (and in particular dimethyl acrylamide), butadiene and isoprene.

One example of a hard/soft/semi-hard particulate copolymer is that comprising, in the following order:

(i) a core made of a methyl methacrylate/ethyl acrylate copolymer;

(ii) a shell made of an n-butyl acrylate/styrene copolymer;

(iii) a shell made of a methyl methacrylate/n-butyl acrylate/styrene copolymer; and

(iv) a shell made of a methyl methacrylate/ethyl acrylate copolymer.

Furthermore, the compositions of the invention may comprise polymethyl methacrylate.

The invention will now be described with reference to the example given below by way of illustration but implying no limitation.

### DETAILED DESCRIPTION OF PARTICULAR EMBODIMENTS

### Example

The following compositions (Comp.1 to Comp.5) were tested:

| | Comp. 1 | Comp. 2 | Comp. 3 | Comp. 4 | Comp. 5 |
|---|---|---|---|---|---|
| SAN | 44 | 27 | 27 | 27 | 27 |
| PMMA | 56 | 33 | 33 | 33 | 33 |
| MBS | — | 40 | | 35 | 30 |
| SBM | — | | 40 | 5 | 10 |

In this table:

SAN denotes a styrene/acrylonitrile copolymer (with an acrylonitrile content of 30% by weight relative to the total weight of the copolymer) having a melt flow rate (MFR) at 210° C. and under a load of 10 kg of 30 g/10 min (measured according to ISO 1133);

PMMA denotes a polymethyl methacrylate with a weight-average molecular weight of 100 kg/mol;

MBS denotes a particulate copolymer comprising a core essentially based on butadiene and styrene and a shell of polymethyl methacrylate; and

SBM denotes a block copolymer comprising a polystyrene block, a polybutadiene block and a polymethyl methacrylate block with a weight-average molecular weight of 80 kg/mol.

The compositions were injection-moulded with an injection temperature of 240° C.

By means of an instrumented drop-weight test, the following were measured:

Fₘₐₓ, denoting the maximum force;

CIE denoting the crack initiation energy;

Eₜₒₜ, denoting the total energy; and

Haze, denoting the turtidity.

The results of the measurements are given in the following table:

| | Comp. 1 | Comp. 2 | Comp. 3 | Comp. 4 | Comp. 5 |
|---|---|---|---|---|---|
| Fₘₐₓ (N) | 325 | 1376 | 366 | 2867 | 3099 |
| CIE (J) | 0.42 | 4.35 | 0.29 | 20 | 24 |
| Eₜₒₜ (J) | 0.53 | 5.69 | 0.83 | 29 | 32 |
| Haze (%) | 2 | 6 | 5 | 4 | 4 |

This table shows that the incorporation of a small amount of SBM into an SAN/PMMA/MBS composition improves its optical properties and its mechanical properties (Comp.4 and Comp.5).

1. Composition comprising:
at least one copolymer (D) comprising repeat units that result from the polymerization of acrylonitrile with at least one vinylaromatic monomer, said copolymer (D) being present with a content ranging from 27 to 80% by weight relative to the total weight of the composition;
at least one particulate copolymer in the form of particles having an elastomeric core and at least one thermoplastic shell, said particulate copolymer being present with a content ranging from 20 to 50% by weight relative to the total weight of the composition;
at least one block copolymer comprising at least three blocks, A, B and C, the three blocks A, B and C being linked together in this order, each block being either a homopolymer or a copolymer obtained from two or more monomers, the A block being linked to the B block and the B block to the C block by means of a covalent bond or of an intermediate bridging group linked to one of these blocks via a covalent bond and to the other block via another covalent bond and such that:
the A block is compatible with the copolymer (D);
the B block is incompatible with the copolymer (D) and is incompatible with the A block; and
the C block is incompatible with the B block, said block copolymer being present with a content ranging from 0.3 to 44% 20% by weight relative to the total weight of the composition.

2. Composition according to claim 1, in which said copolymer (D) is:
present with a content ranging from 30 to 80% by weight relative to the total weight of the composition.

3. Composition according to claim 1, in which said block copolymer is present with a content ranging from 0.3 to 10% by weight relative to the total weight of the composition.

4. Composition according to claim 1, in which the copolymer (D) is chosen from:
linear copolymers resulting from the copolymerization of styrene and acrylonitrile;
graft copolymers comprising a main chain resulting from the polymerization of butadiene or from the copolymerization of butadiene, acrylonitrile and grafts resulting from the polymerization of styrene and acrylonitrile; and
blends of these copolymers.

5. Composition according to claim 1, in which the copolymer (D) has a number-average molecular weight ranging from 10000 to 350000 g/mol.

6. Composition according to claim 1, in which the copolymer (D) has an acrylonitrile mass content lying within the range from 2 to 50%.

7. Composition according to claim 1, in which the block copolymer is an ABC triblock copolymer.

8. Composition according to claim 1, in which the A block is a poly(methyl methacrylate).

9. Composition according to claim 1, in which the A block is a syndiotactic polymethyl methacrylate having a glass transition temperature ranging from +120° C. to +150° C.

10. Composition according to claim 1, in which the B block has a glass transition temperature below 0° C.

11. Composition according to claim 1, in which the B block is a poly(1,4 butadiene).

12. Composition according to claim 1, in which the C block is chosen from styrene or a-methylstyrene homopolymers or copolymers.

13. Composition according to claim 1, in which the A block and the C block are identical.

14. Composition according to claim 1, in which the core is chosen from the group consisting of isoprene copolymers with at most 30 mol % of a vinyl monomer, and butadiene copolymers with at most 30 mol % of a vinyl monomer.

15. Composition according to claim 14, in which the vinyl monomer is chosen from the group consisting of styrene, an alkylstyrene, acrylonitrile and an alkyl(meth)acrylate.

16. Composition according to claim 1, in which the core is chosen from the group consisting of alkyl(meth)acrylate homopolymers and copolymers of an alkyl(meth)acrylate with at most 30 mol % of a monomer chosen from another alkyl(meth)acrylate and a vinyl monomer.

17. Composition according to claim 1, in which the shell consists of:
a styrene, alkylstyrene or methyl methacrylate homopolymer; or
a copolymer comprising at least 70 mol % of a predominant monomer, chosen from styrene, an alkylstyrene or methyl methacrylate, and at least one comonomer chosen from an alkyl(meth)acrylate, vinyl acetate, acrylonitrile, styrene and an alkylstyrene, it being understood that the predominant monomer and the comonomer are different.

18. Composition according to claim 1, in which the particulate copolymer comprises:
(i) 75 to 80 parts of a core comprising at least 93 mol % butadiene, 5 mol % styrene and 0.5 to 1 mol % divinylbenzene; and
(ii) 25 to 20 parts of two shells essentially of the same weight, one, on the inside, made of polystyrene and the other, on the outside, made of polymethyl methacrylate.

19. Composition according to claim 1, in which the particulate copolymer comprises:
(i) a core made of a methyl methacrylate/ethyl acrylate copolymer;
(ii) a shell of an n-butyl acrylate/styrene copolymer; and
(iii) a shell made of a methyl methacrylate/ethyl acrylate copolymer.

20. Composition according to claim 1, in which the particulate copolymer comprises:
(i) a core made of a methyl methacrylate/ethyl acrylate copolymer;
(ii) a shell made of an n-butyl acrylate/styrene copolymer;
(iii) a shell made of a methyl methacrylate/n butyl acrylate/styrene copolymer; and
(iv) a shell made of a methyl methacrylate/ethyl acrylate copolymer.

21. Composition according to claim 1, which further includes polymethyl methacrylate.
